(19) United States
(12) Patent Application Publication
(10) Pub. No.: US 2021/0322880 A1
(43) Pub. Date: Oct. 21, 2021

(54) AUDIO SPATIALIZATION

(71) Applicant: Roblox Corporation, San Mateo, CA (US)

(72) Inventor: David BASZUCKI, Portola Valley, CA (US)

(73) Assignee: Roblox Corporation, San Mateo, CA (US)

(21) Appl. No.: 17/362,857

(22) Filed: Jun. 29, 2021

Related U.S. Application Data
(63) Continuation-in-part of application No. 16/248,835, filed on Jan. 16, 2019.

(51) Int. Cl. A63F 13/54; H04S 7/00; A63F 13/87

(52) U.S. Cl. CPC A63F 13/54; H04S 7/303; A63F 2300/572; A63F 2300/6081; A63F 13/87

(57) ABSTRACT

Methods, systems, and computer-readable media are disclosed that provide audio spatialization processing within an online gaming platform. The method can include programmatically applying audio spatialization to two or more audio messages based on each respective position of two or more avatars within corresponding virtual environments of linked virtual environments, to obtain spatialized audio messages. The method can also include combining the spatialized audio messages and virtual ambient sound to obtain combined audio and providing the combined audio for playback to one or more user devices corresponding to at least one of the two or more avatars.

### CROSS-REFERENCE TO RELATED APPLICATIONS

The present application is a continuation-in-part of U.S. patent application Ser. No. 16/248,835, titled AUDIO SPATIALIZATION and filed Jan. 16, 2019, the contents of which are hereby incorporated herein by reference in their entirety.

### FIELD

This disclosure relates to the field of computerized audio processing and, in particular, to methods, system and computer readable media for audio spatialization within an online gaming platform.

### BACKGROUND

Some online gaming platforms, allow users to connect with each other, interact with each other (e.g., within a game) and share information with each other via the Internet. Users of online gaming platforms may participate in multiplayer gaming environments (e.g., in virtual three-dimensional environments), design custom gaming environments, decorate avatars, exchange virtual items with other users, communicate with other users using audio or text messaging, and so forth.

In order to enhance the realism of an online gaming platform virtual environment and/or to enhance the entertainment aspects of an online game, a need may exist to generate audio that is based on one or more characters (or avatars) in the online game and/or a virtual environment, e.g., a virtual three-dimensional environment, within the online gaming platform virtual environment.

Some implementations were conceived in light of the above-mentioned needs, among other things.

### SUMMARY

According to one aspect, a method is provided. The method can comprise: receiving two or more audio messages, each audio message of the two or more audio messages associated with a respective avatar of two or more avatars, wherein a first avatar of the two or more avatars is in a first virtual environment, wherein a second avatar of the two or more avatars is in a second virtual environment linked to the first virtual environment; determining a respective position of each of the two or more avatars within a corresponding virtual environment; programmatically applying audio spatialization to the two or more audio messages based on the respective position of the two or more avatars within the corresponding virtual environment to obtain spatialized audio messages; determining a respective virtual ambient sound for the first virtual environment and the second virtual environment, wherein the virtual ambient sound is based on a virtual position of one or more objects within the corresponding virtual environment; combining the spatialized audio messages and the virtual ambient sound to obtain combined audio; and providing the combined audio for playback to one or more user devices corresponding to at least one of the two or more avatars.

According to some implementations, the method further comprises modifying the two or more audio messages using an audio filter to obtain modified audio messages.

According to some implementations, modifying the two or more audio messages comprises applying a respective audio filter to at least two of the two or more audio messages.

According to some implementations, the two or more audio messages are modified based on a theme corresponding to at least one of the two or more avatars.

According to some implementations, programmatically applying audio spatialization is performed separately for a given avatar from the two or more avatars to obtain respective spatialized audio messages having a spatialization corresponding to the respective position of the given avatar within the corresponding virtual environment.

According to some implementations, programmatically applying audio spatialization includes applying three-dimensional audio spatialization or applying two-dimensional audio spatialization.

According to some implementations, the virtual ambient sound is further based on one or more of object type, object size, or object shape of the one or more objects within the corresponding virtual environment.

According to some implementations, determining the virtual ambient sound includes determining reflective sound based on at least one of the one or more objects within the virtual environments or one or more virtual materials in the virtual environments.

According to some implementations, combining the spatialized audio messages and the virtual ambient sound further comprises combining the spatialized audio messages, the virtual ambient sound, and a background theme sound to obtain the combined audio, wherein the background theme sound corresponds to a theme of at least one of the virtual environments.

According to some implementations, the first virtual environment is created by a first user, and wherein the second virtual environment is created by a second user different from the first user.

According to some implementations, the combined audio comprises distinct audio generated for each avatar, and wherein providing the combined audio comprises providing the distinct audio for playback at a respective user device.

According to another aspect, a system is provided. The system comprises: a memory with instructions stored thereon; and a processing device, coupled to the memory, the processing device configured to access the memory and execute the instructions, the instructions causing the processing device to perform operations including: receiving two or more audio messages, each audio message of the two or more audio messages associated with a respective avatar of two or more avatars, wherein a first avatar of the two or more avatars is in a first virtual environment, wherein a second avatar of the two or more avatars is in a second virtual environment linked to the first virtual environment; determining a respective position of each of the two or more avatars within a corresponding virtual environment; programmatically applying audio spatialization to the two or more audio messages based on the respective position of the two or more avatars within the corresponding virtual environment to obtain spatialized audio messages; determining a respective virtual ambient sound for the first virtual environment and the second virtual environment, wherein the virtual ambient sound is based on a virtual position of one or more objects within the corresponding virtual environment; combining the spatialized audio messages and the virtual ambient sound to obtain combined audio; and providing the combined audio for playback to one or more user devices corresponding to at least one of the two or more avatars.

According to some implementations, the operations further comprise modifying the two or more audio messages using an audio filter to obtain modified audio messages.

According to some implementations, modifying the two or more audio messages comprises applying a different audio filter to at least two of the two or more audio messages.

According to some implementations, the two or more audio messages are modified based on a theme corresponding to at least one of the two or more avatars.

According to some implementations, combining the spatialized audio messages and the virtual ambient sound further comprises combining the spatialized audio messages, the virtual ambient sound, and a background theme sound to obtain the combined audio, wherein the background theme sound corresponds to a theme of at least one of the virtual environments.

According to yet another aspect, a non-transitory computer-readable medium is provided. The non-transitory computer-readable medium comprises instructions that, responsive to execution by one or more processing devices, cause the one or more processing devices to perform operations comprising: receiving two or more audio messages, each audio message of the two or more audio messages associated with a respective avatar of two or more avatars, wherein a first avatar of the two or more avatars is in a first virtual environment, wherein a second avatar of the two or more avatars is in a second virtual environment linked to the first virtual environment; determining a respective position of each of the two or more avatars within a corresponding virtual environment; programmatically applying audio spatialization to the two or more audio messages based on the respective position of the two or more avatars within the corresponding virtual environment to obtain spatialized audio messages; determining a respective virtual ambient sound for the first virtual environment and the second virtual environment, wherein the virtual ambient sound is based on a virtual position of one or more objects within the corresponding virtual environment; combining the spatialized audio messages and the virtual ambient sound to obtain combined audio; and providing the combined audio for playback to one or more user devices corresponding to at least one of the two or more avatars.

According to some implementations, programmatically applying audio spatialization includes applying three-dimensional audio spatialization or two-dimensional audio spatialization.

According to some implementations, the operations further comprise modifying the two or more audio messages using an audio filter to obtain modified audio messages, wherein modifying the two or more audio messages comprises applying a different audio filter to at least two of the two or more audio messages, and wherein the two or more audio messages are modified based on a theme corresponding to at least one of the two or more avatars.

According to some implementations, combining the spatialized audio messages and the virtual ambient sound further comprises combining the spatialized audio messages, the virtual ambient sound, and a background theme sound to obtain the combined audio, wherein the background theme sound corresponds to a theme of at least one of the virtual environments.

### BRIEF DESCRIPTION OF THE DRAWINGS

Various implementations of the disclosure will be understood more fully from the detailed description given below and from the accompanying drawings of various implementations of the disclosure.

FIG. 1 is a diagram of an example system architecture for online gaming platform audio spatialization in accordance with some implementations.

FIGS. 2A and 2B are diagrams showing an example three-dimensional virtual environment within an online game in accordance with some implementations.

FIG. 3 is a flowchart of an example method of audio spatialization within an online game in accordance with some implementations.

FIG. 4 is a block diagram illustrating an exemplary computing device in accordance with some implementations.

### DETAILED DESCRIPTION

Online gaming platforms (also referred to as “user-generated content platforms” or “user-generated content systems”) offer a variety of ways for users to interact with one another. For example, users of an online gaming platform may work together towards a common goal, share various virtual gaming items, send electronic messages to one another, and so forth. Users of an online gaming platform may play games using characters. An online gaming platform may also allow users of the platform to communicate with each other. For example, users of the online gaming platform may communicate with each other using voice messages (e.g., via voice “chat”), text messaging, video messaging, or a combination of the above. Online gaming platforms can provide a virtual three-dimensional environment in which users can play an online game. In order to help enhance the entertainment value of an online game, the online gaming platform can be operable to provide spatialized audio that is based on the virtual environment that characters corresponding to one or more users are playing in at a given time.

For example, the audio spatialization can include generating audio of player communications (voice chat, etc.) that has been spatialized to simulate the audio characteristics associated with the distance and angle that a speaking character is at within the virtual environment relative to a receiving (or listening) character. For example, if a speaking character is to the right of a listening character and speaks to the listening character, the audio generated for the system of the user corresponding to the listening character can include spatialization that makes the audio sound as if it were coming from the right side of the user (e.g., the audio can be emphasized on a right channel of a stereo audio output device such as speakers or headphones).

In addition to voice communications between characters (or users) within the online gaming platform, audio spatialization can be used to provide simulated ambient sounds. Ambient sounds can include sounds from items within the online game that might typically make sound such as machines or devices (e.g., vehicles, electronics, etc.), simulated natural features of the virtual environment (e.g., animals, weather, sound from plants or trees being moved by wind, etc.). Also, ambient sound audio spatialization can include generating audio that includes reflective sound or echoes based on objects within the virtual game environment. For example, if characters are interacting near metallic objects, the reflected sound from those objects can be processing using audio spatialization techniques and may have different audio characteristics than sound reflected from an object made of a different material, for example a carpeted room, etc.

Voice communications and other audio processing within an online gaming environment may have one or more technical problems. For example, voice communication of some users may need to be modified so that the audio that is generated for a receiving user has sound qualities that suggest the voice communications are coming from a location (e.g., distance, angle, etc.) of the speaking character relative to a receiving or listening character. Some implementations of the disclosed subject matter can include audio spatialization techniques that provide a technical solution to the problem of producing voice communications or other sounds that simulate a location relative to a receiving or listening characters within a virtual three-dimensional environment of an online gaming platform.

Also, an online gaming platform may have a need to provide ambient sound corresponding to a virtual environment in an online gaming platform. Some implementations provide a solution to the technical problem of matching ambient sound to a virtual three-dimensional environment of an online gaming platform including ambient sound based on objects within the virtual three-dimensional environment including the virtual location, type of material, etc. of the objects.

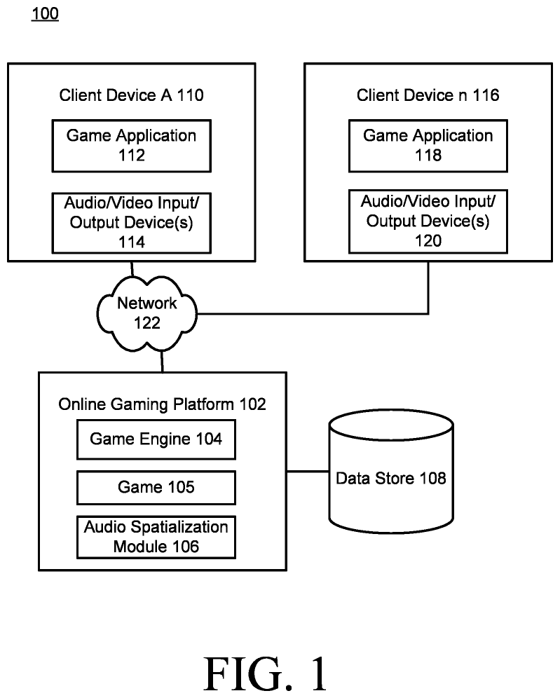

FIG. 1 illustrates an example system architecture 100, in accordance with some implementations of the disclosure. The system architecture 100 (also referred to as “system” herein) includes an online gaming platform 102, a first client device 110 (generally referred to as “client device(s) 110” herein), a network 122, and a second client device 116. The online gaming platform 102 can include, among other things, a game engine 104, one or more games 105, a audio spatialization module 106, and a data store 108. The client system 110 can include a game application 112 and input/output devices 114 (e.g., audio/video input/output devices). The client system 116 can include a game application 118 and input/output devices 120 (e.g., audio/video input/output devices). The audio/video input/output devices can include one or more of a microphone, speakers, headphones, display device, etc.

System architecture 100 is provided for illustration, rather than limitation. In some implementations, the system architecture 100 may include the same, fewer, more, or different elements configured in the same or different manner as that shown in FIG. 1.

In one implementation, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In one implementation, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online gaming platform 102 can include a server having one or more computing devices (e.g., a cloud computing system, a rackmount server, a server computer, cluster of physical servers, etc.). In some implementations, a server may be included in the online gaming platform 102, be an independent system, or be part of another system or platform.

In some implementations, the online gaming platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online gaming platform 102 and to provide a user with access to online gaming platform 102. The online gaming platform 102 may also include a web site (e.g., a webpage) or application back-end software that may be used to provide a user with access to content provided by online gaming platform 102. For example, users may access online gaming platform 102 using the game application 112 on client devices 110.

In some implementations, online gaming platform 102 may be a type of social network providing connections between users or a type of user-generated content system that allows users (e.g., end-users or consumers) to communicate with other users on the online gaming platform 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online gaming platform 102 may be a virtual gaming platform. For example, the gaming platform may provide single-player or multiplayer games to a community of users that may access or interact with games using client devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to interaction of one or more players using client devices (e.g., 110 and/or 116) within a game (e.g., 105) or the presentation of the interaction on a display or other output device (e.g., 118/132) of a client device 110 or 124.

In some implementations, a game 105 can include an electronic file that can be executed or loaded using software, firmware or hardware configured to present the game content (e.g., digital media item) to an entity. In some implementations, a game application 112 may be executed and a game 105 rendered in connection with a game engine 104. In some implementations, a game 105 may have a common set of rules or common goal, and the environments of a game 105 share the common set of rules or common goal. In some implementations, different games may have different rules or goals from one another.

In some implementations, games may have one or more environments (also referred to as “virtual experiences,” “gaming environments,” or “virtual environments” herein) where multiple environments may be linked. An example of an environment may be a three-dimensional (3D) environment. The one or more environments of a game application 105 may be collectively referred to a “world” or “gaming world” or “virtual world” or “universe” herein. An example of a world may be a 3D world of a game 105. For example, a user may build a virtual environment that is linked to another virtual environment created by another user. Thus, a first virtual environment may be linked to a second virtual environment created by a second user, different from the first user, and so forth. Any number of virtual environments may be linked with each other. A character of the virtual game or environment may cross the virtual border to enter the adjacent virtual environment. For example, the virtual border may delineate a separation between two linked virtual environments, and a first user may be in a first virtual environment, a second user may be in a second virtual environment, and the first user and second user may communicate over the virtual border. For example, in at least one implementation, the first user may engage in voice chat with the second user over the virtual border, and the voice chat may include spatialized audio as described herein. Virtual borders may delineate various pairs of linked environments.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online gaming platform 102 can host one or more games 105 and can permit users to interact with the games 105 using a game application 112 of client devices 110. Users of the online gaming platform 102 may play, create, interact with, or build games 105, communicate with other users, and/or create and build objects (e.g., also referred to as “item(s)” or “game objects” or “virtual game item(s)” herein) of games 105. For example, in generating user-generated virtual items, users may create characters, decoration for the characters, one or more virtual environments for an interactive game, or build structures used in a game 105, among others. In some implementations, users may buy, sell, or trade game virtual game objects, such as in-platform currency (e.g., virtual currency), with other users of the online gaming platform 102. In some implementations, online gaming platform 102 may transmit game content to game applications (e.g., 112). In some implementations, game content (also referred to as “content” herein) may refer to any data or software instructions (e.g., game objects, game, user information, video, images, commands, media item, etc.) associated with online gaming platform 102 or game applications. In some implementations, game objects (e.g., also referred to as “item(s)” or “objects” or “virtual game item(s)” herein) may refer to objects that are used, created, shared or otherwise depicted in game applications 105 of the online gaming platform 102 or game applications 112 or 118 of the client devices 110/116. For example, game objects may include a part, model, character, tools, weapons, clothing, buildings, vehicles, currency, flora, fauna, components of the aforementioned (e.g., windows of a building), and so forth.

It may be noted that the online gaming platform 102 hosting games 105, is provided for purposes of illustration, rather than limitation. In some implementations, online gaming platform 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a game 105 may be associated with a particular user or a particular group of users (e.g., a private game), or made widely available to users of the online gaming platform 102 (e.g., a public game). In some implementations, where online gaming platform 102 associates one or more games 105 with a specific user or group of users, online gaming platform 102 may associated the specific user(s) with a game 102 using user account information (e.g., a user account identifier such as username and password).

In some implementations, online gaming platform 102 or client devices 110 may include a game engine 104 or game application 112/118. In some implementations, game engine 104 may be used for the development or execution of games 105. For example, game engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the game engine 104 may generate commands that help compute and render the game (e.g., rendering commands, collision commands, physics commands, etc.) In some implementations, game applications 112/118 of client devices 110/116, respectively, may work independently, in collaboration with game engine 104 of online gaming platform 102, or a combination of both.

In some implementations, both the online gaming platform 102 and client devices 110/116 execute a game engine (104, 112, and 118, respectively). The online gaming platform 102 using game engine 104 may perform some or all the game engine functions (e.g., generate physics commands, rendering commands, etc.), or offload some or all the game engine functions to game engine 104 of client device 110. In some implementations, each game 105 may have a different ratio between the game engine functions that are performed on the online gaming platform 102 and the game engine functions that are performed on the client devices 110 and 116. For example, the game engine 104 of the online gaming platform 102 may be used to generate physics commands in cases where there is a collision between at least two game objects, while the additional game engine functionality (e.g., generate rendering commands) may be offloaded to the client device 110. In some implementations, the ratio of game engine functions performed on the online gaming platform 102 and client device 110 may be changed (e.g., dynamically) based on gameplay conditions. For example, if the number of users participating in gameplay of a particular game 105 exceeds a threshold number, the online gaming platform 102 may perform one or more game engine functions that were previously performed by the client devices 110 or 116.

For example, users may be playing a game 105 on client devices 110 and 116, and may send control instructions (e.g., user inputs, such as right, left, up, down, user election, or character position and velocity information, etc.) to the online gaming platform 102. Subsequent to receiving control instructions from the client devices 110 and 116, the online gaming platform 102 may send gameplay instructions (e.g., position and velocity information of the characters participating in the group gameplay or commands, such as rendering commands, collision commands, etc.) to the client devices 110 and 116 based on control instructions. For instance, the online gaming platform 102 may perform one or more logical operations (e.g., using game engine 104) on the control instructions to generate gameplay instruction for the client devices 110 and 116. In other instances, online gaming platform 102 may pass one or more or the control instructions from one client device 110 to other client devices (e.g., 116) participating in the game 105. The client devices 110 and 116 may use the gameplay instructions and render the gameplay for presentation on the displays of client devices 110 and 116.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online gaming platform 102. In other implementations, the control instructions may be sent from a client device 110 to another client device (e.g., 116), where the other client device generates gameplay instructions using the local game engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a client device 110 (or 116) to render gameplay of a game, such as a multiplayer game. The gameplay instructions may include one or more of user input (e.g., control instructions), character position and velocity information, or commands (e.g., physics commands, rendering commands, collision commands, etc.).

In some implementations, characters (or game objects generally) are constructed from components, one or more of which may be selected by the user, that automatically join together to aid the user in editing. One or more characters (also referred to as an “avatar” or “model” herein) may be associated with a user where the user may control the character to facilitate a user's interaction with the game 105. In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools. In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character game object (e.g., body parts, etc.) but the user may control the character (without the character game object) to facilitate the user's interaction with the game (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online gaming platform 102. In some implementations, creating, modifying, or customizing characters, other game objects, games 105, or game environments may be performed by a user using a user interface (e.g., developer interface) and with or without scripting (or with or without an application programming interface (API)). It may be noted that for purposes of illustration, rather than limitation, characters are described as having a humanoid form. In may further be noted that characters may have any form such as a vehicle, animal, inanimate object, or other creative form.

In some implementations, the online gaming platform 102 may store characters created by users in the data store 108. In some implementations, the online gaming platform 102 maintains a character catalog and game catalog that may be presented to users via. In some implementations, the game catalog includes images of games stored on the online gaming platform 102. In addition, a user may select a character (e.g., a character created by the user or other user) from the character catalog to participate in the chosen game. The character catalog includes images of characters stored on the online gaming platform 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online gaming platform 102.

In some implementations, the client device(s) 110 or 116 may each include computing devices such as personal computers (PCs), mobile devices (e.g., laptops, mobile phones, smart phones, tablet computers, or netbook computers), network-connected televisions, gaming consoles, etc. In some implementations, a client device 110 or 116 may also be referred to as a “user device.” In some implementations, one or more client devices 110 or 116 may connect to the online gaming platform 102 at any given moment. It may be noted that the number of client devices 110 or 116 is provided as illustration, rather than limitation. In some implementations, any number of client devices 110 or 116 may be used.

In some implementations, each client device 110 or 116 may include an instance of the game application 112 or 118, respectively. In one implementation, the game application 112 or 118 may permit users to use and interact with online gaming platform 102, such as control a virtual character in a virtual game hosted by online gaming platform 102, or view or upload content, such as games 105, images, video items, web pages, documents, and so forth. In one example, the game application may be a web application (e.g., an application that operates in conjunction with a web browser) that can access, retrieve, present, or navigate content (e.g., virtual character in a virtual environment, etc.) served by a web server. In another example, the game application may be a native application (e.g., a mobile application, app, or a gaming program) that is installed and executes local to client device 110 or 116 and allows users to interact with online gaming platform 102. The game application may render, display, or present the content (e.g., a web page, a media viewer) to a user. In an implementation, the game application may also include an embedded media player (e.g., a Flash® player) that is embedded in a web page.

According to aspects of the disclosure, the game application may be an online gaming platform application for users to build, create, edit, upload content to the online gaming platform 102 as well as interact with online gaming platform 102 (e.g., play games 105 hosted by online gaming platform 102). As such, the game application may be provided to the client device 110 or 116 by the online gaming platform 102. In another example, the game application may be an application that is downloaded from a server.

In some implementations, a user may login to online gaming platform 102 via the game application. The user may access a user account by providing user account information (e.g., username and password) where the user account is associated with one or more characters available to participate in one or more games 105 of online gaming platform 102.

In general, functions described in one implementation as being performed by the online gaming platform 102 can also be performed by the client device(s) 110 or 116, or a server, in other implementations if appropriate. In addition, the functionality attributed to a particular component can be performed by different or multiple components operating together. The online gaming platform 102 can also be accessed as a service provided to other systems or devices through appropriate application programming interfaces (APIs), and thus is not limited to use in websites.

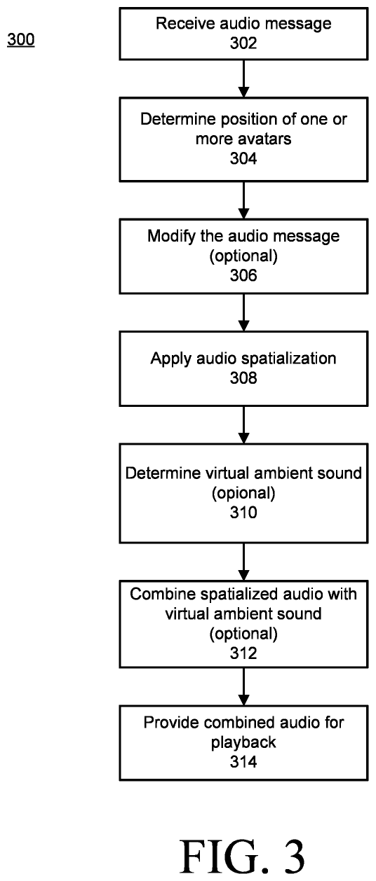

In some implementations, online gaming platform 102 may include an audio spatialization module 106. In some implementations, the audio spatialization module 106 may be a system, application, or module that permits the online gaming platform 102 to provide audio spatialization. In some implementations, the audio spatialization module 106 may perform one or more of the operations described below in connection with the flowchart shown in FIG. 3.

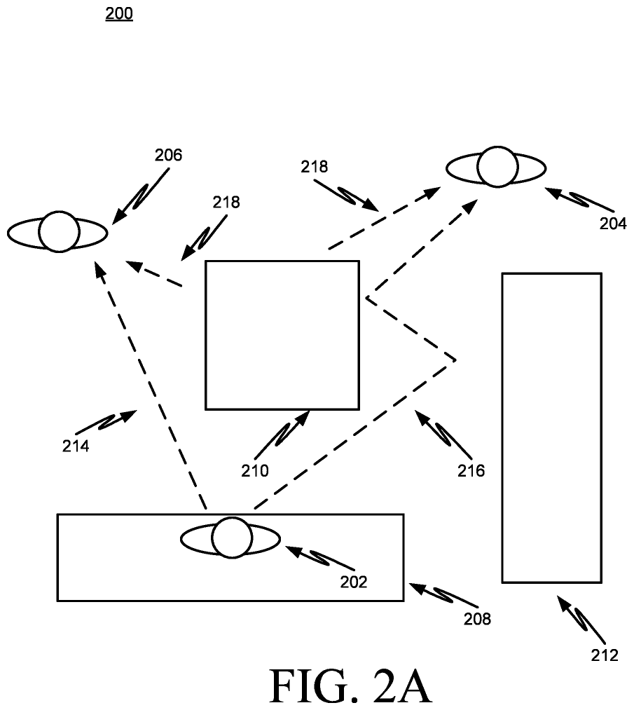

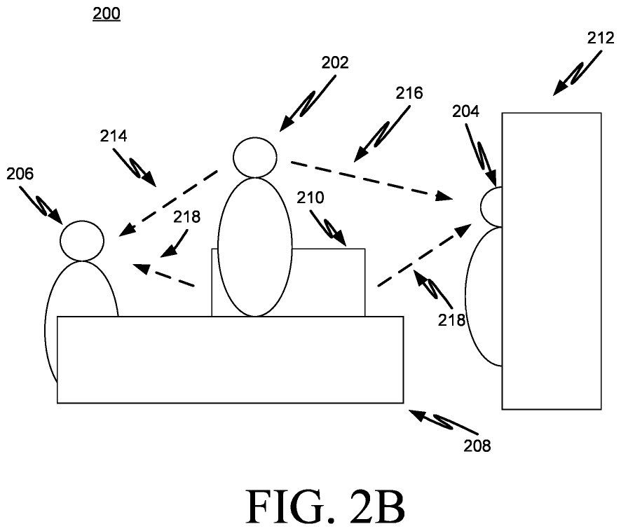

FIGS. 2A and 2B are diagrams showing an example virtual environment 200 within an online game in accordance with some implementations. The virtual environment 200 includes a first character 202, a second character 204, and a third character 206. The characters (202-206) can include characters controlled by a respective user and/or characters under automatic control of the online gaming platform (e.g., computer generated characters).

In addition to characters 202-206, the virtual environment 200 includes a first virtual object 208, a second virtual object 210, and a third virtual object 212. The virtual objects can represent, among other things, buildings, components of buildings (e.g., walls, windows, doors, etc.), bodies of water (e.g., ponds, rivers, lakes, oceans, etc.), furniture, machines, vehicles, plants, animals, etc. The virtual objects (208-212) can include associated data or metadata that corresponds to one or more object characteristics such as material type (e.g., metal, wood, cloth, stone, etc.), object location within the virtual environment, object size, object shape, or object sound characteristics (e.g., ambient sound object makes, how often sound is made, volume of sound, etc.).

The object sound characteristics can be based on object type, object size, object shape, or object location. For example, an object representing a full grown large dog may have a sound characteristic that is typical of a full grown dog (object type) that is large (object size) and is located at a given position relative to a character (object location). The sound characteristics can include an ambient sound the object makes (e.g., barking sound) that can be provided by a sound file (e.g., computer generated sound or recorded sound). Further, the sound characteristics can include a frequency that the object makes sound (e.g., how often the dog barks) and a volume of the ambient sound (e.g., how loud the dog bark is at a given distance). The volume of the ambient sound of the object can subsequently be modified as part of the audio spatialization process (e.g., the dog bark can be made louder for a dog that is close to the character and can be made quieter for a dog that is further away from the character).

In the example shown in FIGS. 2A and 2B, the objects can include furniture or parts of a building. For example, virtual object 208 can be a platform on which character 202 is standing. Virtual object 210 can be a table situated on the floor. Virtual object 212 can be a wall.

Character 202 can be speaking and emitting simulated sound as shown by sound paths 214 and 216. The voice of character 202 along sound path 214 is coming from the left of character 206 and along sound path 216 is coming from the right of character 204 within the virtual environment. The path of the sound between character 202 and character 206 is direct, while the path of the sound from character 202 to characters 204 is partially reflected off of the wall 212 and table 210 as shown by sound path 216.

Further, ambient sound can be emitted by the table 210. For example, the table could include a speaker or other object on the table that is emitting sound. The ambient sound is shown by sound paths 218.

In operation, an implementation of the audio spatialization techniques described herein could perform one or more of the following operations based on the example three-dimensional environment shown in FIGS. 2A and 2B: 1) spatialization of the voice communications of a character (e.g., character 202) based on the position of a respective receiving character (e.g., 204 or 206) with respect to the character speaking; 2) audio spatialization of the voice communications based on any objects within the virtual environment (e.g., 208, 210, or 212); and 3) audio spatialization of ambient sounds (e.g., sound emitted by object 210) within the virtual environment. In some implementations, the game application running on the client device can maintain information about the location of each character in the game. Also, the game application running on the client device can maintain information about the location of each object in the game and meta data about the properties of those objects.

In some implementations, ambient sounds may include things like wind, rain, music, machinery, etc. Ambient sounds may also include sounds emanating from objects (e.g. a car) that may be stationary or moving around the environment. The online game platform delivers information to the client device which includes the sound.

FIG. 3 is a flowchart of an example method 300 to spatialized audio within an online game in accordance with some implementations. Processing begins at 302, where one or more audio messages are received. In some implementations, each audio message can be associated with a respective avatar of one or more avatars within one or more virtual environments. The one or more virtual environments may be linked virtual environments, and the linked virtual environments may have a virtual border disposed there-between. For example, a respective virtual border may be provided between each pair of linked virtual environments. According to one implementation, two or more audio messages are received, each audio message of the two or more audio messages is associated with a respective avatar of two or more avatars within virtual environments. According to one implementation, a first avatar of the one or more avatars is in a first virtual environment, a second avatar of the one or more avatars is in a second virtual environment linked to the first virtual environment, the first virtual environment is created by a first user, and the second virtual environment is created by a second user different from the first user. Additionally, the first avatar may have a theme associated therewith and/or the second avatar may have a theme associated therewith. Furthermore, the first virtual environment may have a theme associated therewith and/or the second virtual environment may have a theme associated therewith. The audio messages can be discrete, asynchronous audio messages or can be messages forming part of a conversation between characters (e.g., user controlled characters and/or computer controller characters). The audio messages from user controlled characters can be received via an audio input device (e.g., microphone) could to a client system associated with the user. Audio messages from a computer controlled character can include computer generated voice messages. Processing continues to 304.

At 304, positions or locations of one or more avatars within a respective virtual environment of the virtual environments (e.g., the linked virtual environments) are determined. For example, the system can determine the position of one or more avatars (e.g., 304 or 206) that are receiving the audio voice communication sent by another avatar (e.g., 202). The positions of avatars can be determined from an online gaming platform that is maintaining a position of each avatar within an online game. The positions of the avatars can be determined relative to an avatar that is speaking. For example, the positions of avatars 204 and 206 can be determined relative to avatar 202, which is speaking in the example shown in FIGS. 2A and 2B. The positions of the avatars can also be determined within each of the two or more linked virtual environments, positions of any associated objects can also be determined within the linked virtual environments, any virtual borders connecting the linked virtual environments can also be determined, and/or any other aspects that may affect sound propagation related to the linked virtual environments can also be determined. Processing continues to 306.

At 306, the audio message can be optionally modified. For example, the audio message may be modified to alter the sound and characteristic of a user to protect privacy or based on a preference of the user. In some implementations, the audio can be modified according to a theme. The theme may be an avatar theme (e.g., the user's voice could be modified to a pirate voice to match a pirate avatar theme), a user selected theme (e.g., the user selects for the avatar to speak in a robot voice or to match a robot theme), a virtual environment theme (e.g., the user's voice could be modified to a voice pattern or characteristic associated with a surrounding environment's theme, such as a pizza parlor, spaceship, opera house, etc.), a user-selection (e.g., the user selects a particular theme or audio filter), or another associated theme.

In some implementations, modifying the audio messages can include applying a first filter to each of the one or more audio messages. The first filter can include a filter to modify the tone and/or other audio characteristics of the one or more audio messages. In some implementations, the one or more audio messages include at least two messages and modifying the audio messages includes applying a different filter to at least two of the one or more audio messages. In some implementations, the audio filters can include a synthesized voice. In some implementations, the audio filters can include a filter to modify sounds based on a theme (e.g., modify background sounds based on a virtual environment's theme). In some implementations, the audio filters can include a filter to modify voices based on a theme (e.g., modify voices to match an avatar theme and/or a virtual environment's theme). Processing continues to 308.

At 308, audio spatialization is programmatically applied to the one or more audio messages. Audio spatialization can include generating audio based on the one or more of the position of the one or more avatars within a corresponding virtual environment and the modified audio message if the audio message was modified at step 306 or the unmodified audio message if step 306 was not performed. In some implementations, the audio spatialization can include generating audio based on relative positions of the two or more avatars with respect to a virtual border between the linked virtual environments. In some implementations, audio spatialization can include generating audio based on relative positions of the two or more avatars, relative positions of objects between and/or around the two or more avatars, associated avatar themes, associated virtual environment themes, and/or other aspects that affect sound propagation associated with the linked virtual environments.

In some implementations, programmatically applying audio spatialization can be performed separately for a given avatar from the one or more avatars to obtain respective spatialized audio messages having a spatialization corresponding to the respective position of the given avatar within the corresponding virtual environment. In some implementations, programmatically applying audio spatialization can include applying three-dimensional audio spatialization. In some implementations, programmatically applying audio spatialization can include applying two-dimensional audio spatialization.

Audio spatialization can include calculating how sound would be heard at a given location (e.g., a location of a receiving avatar) within a corresponding virtual environment based on the location of a speaking or transmitting avatar within: a different linked virtual environment, the same virtual environment, and/or the virtual border between linked virtual environments. Also, audio spatialization can include modifying the audio message based on the calculation for how the sound would be heard.

Audio spatialization can include applying one or more three-dimensional audio effects, which can include one or more of a group of sound effects to manipulate sound produced by audio output devices such as stereo speakers, surround-sound speakers, speaker-arrays, headphones, or specialized audio output devices operable to provide three-dimensional sound. Audio spatialization can include virtual placement of sound sources anywhere in three-dimensional space, including behind, above or below the listener.

Audio spatialization can include three-dimensional audio processing in which the spatial domain of sound waves is convoluted using a technique such as a head-related transfer function (HRTF) or the like. In some implementations, sound waves can be transformed (e.g., using HRTF filters and/or cross talk cancellation techniques) to simulate natural sound waves, which emanate from one or more points three-dimensional space. Audio spatialization essentially tricks the brain of a user via the ears and auditory nerves so as to simulate different sounds emanating in different three-dimensional locations upon hearing the sounds. The sounds may appear to a user to be coming from different point in a three-dimensional environment (e.g., the virtual game environment) even though the sounds may just be produced from two speakers or earphones.

In some implementations, effects such as head-related transfer functions and reverberation techniques can be used to simulate the changes of sound as it travels from a source (including reflections from walls, floors, or other objects) to the listener's ear. These effects can include localization of sound sources behind, above and below the listener. Some implementations can include the simulation of real world effects to sound as the sound travels through a virtual physical environment. Processing continues to 310.

At 310, ambient sound of a virtual three-dimensional game environment can optionally be determined. In some implementations, determining the virtual ambient sound can include determining reflective sound based on at least one of one or more virtual objects in the virtual environment or one or more virtual materials in the virtual environment. The ambient sound can be based on any objects within the three-dimensional virtual environment. Objects can include buildings, components of buildings (e.g., walls, windows, doors, etc.), bodies of water (e.g., ponds, rivers, lakes, oceans, etc.), furniture, machines, vehicles, plants, animals, etc. Ambient sound can also be based on sound sources that are not specific objects in an environment, but rather sound sources based on a design of a virtual three-dimensional environment or a theme of the virtual three-dimensional environment. Object definitions can include sound respective objects create and is sent from the online gaming platform to the game application. Processing continues to 312.

At 312, the spatialized audio messages and the virtual ambient sound can optionally be combined to obtain combined audio. In some implementations, the combining can include mixing the spatialized audio messages and the virtual ambient sound according to a weighting or other parameters. In some implementations, the sound can be mixed according to a static or dynamic mixing ratio for the spatialized audio messages and the virtual ambient sound. In some implementations, the combining can include combining the spatialized audio messages, the virtual ambient sound, and a background theme sound to obtain the combined audio. The background theme sound can correspond to a theme of at least one of the virtual environments.

The combined audio will be distinct for each of the avatars, based on the audio message to be received, its own ambient sound, and the position/properties of objects in its virtual environment.

As an example, consider a scenario where Avatar A is in a cave; Avatar B is at the beach; while the cave and beach share a virtual border. In this example, Avatar A receives Avatar B's speech, suitably modified for spatialization and to include echo/reverb (e.g., based on the cave characteristics). Similarly, Avatar B receives Avatar A's speech, suitably modified for spatialization and to include ambient sounds of waves and birds at the beach. If another Avatar C, which is positioned in a conference room, receives Avatar A's speech, it will be modified differently (e.g., all echo removed because of presence of absorptive objects in the conference room) than it is for Avatar B. Accordingly, the combined audio for each Avatar will be different, and comprise distinct audio generated for each respective avatar. Thus, different combined audio can be generated for each avatar, and can be provided for playback at a respective user device. Processing continues to 314.

At 314, the combined audio is provided for playback to one or more client devices. For example, in some implementations, the combined audio can be sent to one or more client devices (110 and/or 116) for output through audio output devices such as headphones or speakers.

Steps 302-314 can be performed (or repeated) in a different order than described above and/or one or more steps can be omitted.

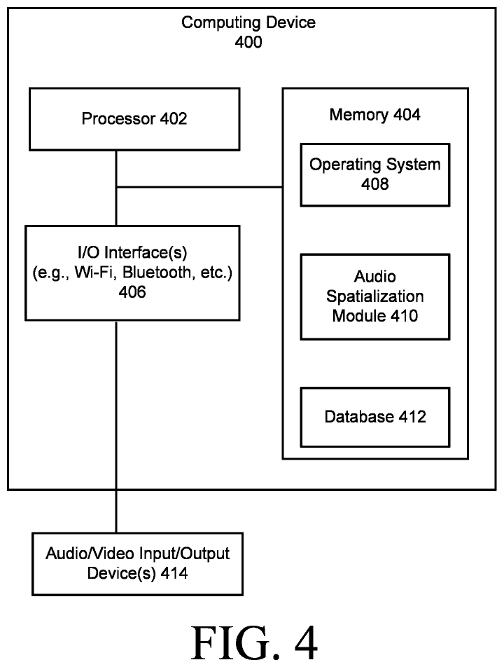

FIG. 4 is a block diagram of an example computing device 400 which may be used to implement one or more features described herein. In one example, device 400 may be used to implement a computer device, (e.g., 102, 110, and/or 116 of FIG. 1), and perform appropriate method implementations described herein. Computing device 400 can be any suitable computer system, server, or other electronic or hardware device. For example, the computing device 400 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 400 includes a processor 402, a memory 404, input/output (I/O) interface 406, and audio/video input/output devices 414.

Processor 402 can be one or more processors and/or processing circuits to execute program code and control basic operations of the device 400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 404 is typically provided in device 400 for access by the processor 402, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 402 and/or integrated therewith. Memory 404 can store software operating on the server device 400 by the processor 402, including an operating system 608, one or more applications 410, e.g., a audio spatialization application and application data 412. In some implementations, application 410 can include instructions that enable processor 402 to perform the functions described herein, e.g., some or all of the method of FIG. 3.

For example, applications 410 can include an audio spatialization module 412, which as described herein can provide audio spatialization within an online gaming platform (e.g., 102). Any of software in memory 404 can alternatively be stored on any other suitable storage location or computer-readable medium. In addition, memory 404 (and/or other connected storage device(s)) can store instructions and data used in the features described herein. Memory 404 and any other type of storage (magnetic disk, optical disk, magnetic tape, or other tangible media) can be considered “storage” or “storage devices.”

I/O interface 406 can provide functions to enable interfacing the server device 400 with other systems and devices. For example, network communication devices, storage devices (e.g., memory and/or data store 108), and input/output devices can communicate via interface 406. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 414 can include a display device, an audio input device (e.g., a microphone, etc.) that can be used to receive audio messages as input, and/or an audio output device (e.g., speakers, headphones, etc.) that can be used to provide audio output such as the combined audio output of step 314 of FIG. 3.

For ease of illustration, FIG. 4 shows one block for each of processor 402, memory 404, I/O interface 406, and software blocks 408 and 410. These blocks may represent one or more processors or processing circuitries, operating systems, memories, I/O interfaces, applications, and/or software modules. In other implementations, device 400 may not have all of the components shown and/or may have other elements including other types of elements instead of, or in addition to, those shown herein. While the online gaming platform 102 is described as performing operations as described in some implementations herein, any suitable component or combination of components of online gaming platform 102 or similar system, or any suitable processor or processors associated with such a system, may perform the operations described.

A user device can also implement and/or be used with features described herein. Example user devices can be computer devices including some similar components as the device 400, e.g., processor(s) 402, memory 404, and I/O interface 406. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 414, for example, can be connected to (or included in) the device 400 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving two or more audio messages, each audio message of the two or more audio messages associated with a respective avatar of two or more avatars, wherein a first avatar of the two or more avatars is in a first virtual environment, wherein a second avatar of the two or more avatars is in a second virtual environment linked to the first virtual environment;
determining a respective position of each of the two or more avatars within a corresponding virtual environment;
programmatically applying audio spatialization to the two or more audio messages based on the respective position of the two or more avatars within the corresponding virtual environment to obtain spatialized audio messages;
determining a respective virtual ambient sound for the first virtual environment and the second virtual environment, wherein the virtual ambient sound is based on a virtual position of one or more objects within the corresponding virtual environment;
combining the spatialized audio messages and the virtual ambient sound to obtain combined audio; and
providing the combined audio for playback to one or more user devices corresponding to at least one of the two or more avatars.

2. The computer-implemented method of claim 1, further comprising modifying the two or more audio messages using an audio filter to obtain modified audio messages.

3. The computer-implemented method of claim 2, wherein modifying the two or more audio messages comprises applying a respective audio filter to at least two of the two or more audio messages.

4. The computer-implemented method of claim 2, wherein the two or more audio messages are modified based on a theme corresponding to at least one of the two or more avatars.

5. The computer-implemented method of claim 1, wherein programmatically applying audio spatialization is performed separately for a given avatar from the two or more avatars to obtain respective spatialized audio messages having a spatialization corresponding to the respective position of the given avatar within the corresponding virtual environment.

6. The computer-implemented method of claim 1, wherein programmatically applying audio spatialization includes applying three-dimensional audio spatialization or applying two-dimensional audio spatialization.

7. The computer-implemented method of claim 1, wherein the virtual ambient sound is further based on one or more of object type, object size, or object shape of the one or more objects within the corresponding virtual environment.

8. The computer-implemented method of claim 1, wherein determining the virtual ambient sound includes determining reflective sound based on at least one of the one or more objects within the virtual environments or one or more virtual materials in the virtual environments.

9. The computer-implemented method of claim 1, wherein combining the spatialized audio messages and the virtual ambient sound further comprises combining the spatialized audio messages, the virtual ambient sound, and a background theme sound to obtain the combined audio, wherein the background theme sound corresponds to a theme of at least one of the virtual environments.

10. The computer-implemented method of claim 1, wherein the first virtual environment is created by a first user, and wherein the second virtual environment is created by a second user different from the first user.

11. The computer-implemented method of claim 1, wherein the combined audio comprises distinct audio generated for each avatar, and wherein providing the combined audio comprises providing the distinct audio for playback at a respective user device.

12. A system comprising:
a memory with instructions stored thereon; and
a processing device, coupled to the memory, the processing device configured to access the memory and execute the instructions, the instructions causing the processing device to perform operations including:
receiving two or more audio messages, each audio message of the two or more audio messages associated with a respective avatar of two or more avatars, wherein a first avatar of the two or more avatars is in a first virtual environment, wherein a second avatar of the two or more avatars is in a second virtual environment linked to the first virtual environment;
determining a respective position of each of the two or more avatars within a corresponding virtual environment;
programmatically applying audio spatialization to the two or more audio messages based on the respective position of the two or more avatars within the corresponding virtual environment to obtain spatialized audio messages;
determining a respective virtual ambient sound for the first virtual environment and the second virtual environment, wherein the virtual ambient sound is based on a virtual position of one or more objects within the corresponding virtual environment;
combining the spatialized audio messages and the virtual ambient sound to obtain combined audio; and
providing the combined audio for playback to one or more user devices corresponding to at least one of the two or more avatars.

13. The system of claim 12, wherein the operations further comprise modifying the two or more audio messages using an audio filter to obtain modified audio messages.

14. The system of claim 13, wherein modifying the two or more audio messages comprises applying a different audio filter to at least two of the two or more audio messages.

15. The system of claim 13, wherein the two or more audio messages are modified based on a theme corresponding to at least one of the two or more avatars.

16. The system of claim 11, wherein combining the spatialized audio messages and the virtual ambient sound further comprises combining the spatialized audio messages, the virtual ambient sound, and a background theme sound to obtain the combined audio, wherein the background theme sound corresponds to a theme of at least one of the virtual environments.

17. A non-transitory computer-readable medium comprising instructions that, responsive to execution by one or more processing devices, cause the one or more processing devices to perform operations comprising:
receiving two or more audio messages, each audio message of the two or more audio messages associated with a respective avatar of two or more avatars, wherein a first avatar of the two or more avatars is in a first virtual environment, wherein a second avatar of the two or more avatars is in a second virtual environment linked to the first virtual environment;
determining a respective position of each of the two or more avatars within a corresponding virtual environment;
programmatically applying audio spatialization to the two or more audio messages based on the respective position of the two or more avatars within the corresponding virtual environment to obtain spatialized audio messages;
determining a respective virtual ambient sound for the first virtual environment and the second virtual environment, wherein the virtual ambient sound is based on a virtual position of one or more objects within the corresponding virtual environment;
combining the spatialized audio messages and the virtual ambient sound to obtain combined audio; and
providing the combined audio for playback to one or more user devices corresponding to at least one of the two or more avatars.

18. The non-transitory computer-readable medium of claim 17, wherein programmatically applying audio spatialization includes applying three-dimensional audio spatialization or two-dimensional audio spatialization.

19. The non-transitory computer-readable medium of claim 17, wherein the operations further comprise modifying the two or more audio messages using an audio filter to obtain modified audio messages, wherein modifying the two or more audio messages comprises applying a different audio filter to at least two of the two or more audio messages, and wherein the two or more audio messages are modified based on a theme corresponding to at least one of the two or more avatars.

20. The non-transitory computer-readable medium of claim 17, wherein combining the spatialized audio messages and the virtual ambient sound further comprises combining the spatialized audio messages, the virtual ambient sound, and a background theme sound to obtain the combined audio, wherein the background theme sound corresponds to a theme of at least one of the virtual environments.
